(19) United States
(12) Patent Application Publication
(10) Pub. No.: US 2011/0145147 A1
(43) Pub. Date: Jun. 16, 2011

(54) SYSTEM AND METHOD FOR AUTHORIZING TRANSACTIONS

(76) Inventor: Michael S. Wylie, Gallup, NM (US)

(21) Appl. No.: 12/763,731

(22) Filed: Apr. 20, 2010

Related U.S. Application Data
(60) Provisional application No. 61/286,297, filed on Dec. 14, 2009.

(51) Int. Cl. G06Q 40/00; G06K 5/00; G06F 17/30

(52) U.S. Cl. 705/44; 235/380; 707/781; 707/812; 707/E17.005; 707/E17.009

(57) ABSTRACT

A method and system for authorizing a transaction that includes a remote location where the transaction takes place from which purchaser information may be obtained and providing that information to a central site where pre-determined information regarding the customer exists. Storing legal information at that central site provides the criterion for determining authorization by comparing the purchaser data with the stored legal information. The transaction data is stored, authorization is transmitted to the remote location, and the transaction authorization is transmitted to a temporary database available for near real-time access solely by law enforcement officers.

### RELATED APPLICATION

This application claims the benefit of U.S. Provisional Patent Application Ser. No. 61/286,297.

### BACKGROUND AND SUMMARY

The present invention relates generally to methods, systems, and computer programs configured for authorizing transactions requiring compliance with private or public approval standards. One embodiment of the present invention includes a first method, including a computerized database which may be accessed from remote locations for the purpose of seeking authorization for a transaction occurring at the remote location. The first method may also include transmission of information from a remote location to a central site seeking authorization, determining whether authorization may be granted by inquiry to the database containing public and/or private information and re-transmitting authorization, or a refusal to authorize, to the remote location.

A second embodiment of the present invention includes a first computer program product including a computer readable storage medium having computer readable program code embodied therein, the computer readable code includes computer readable program code for receiving a coded message, and further including computer readable program code to authorize a remote user to complete a transaction in response to information transmitted in the coded message. The computer readable program code of the first computer program product includes computer readable program code to identify the entity at the remote location in response to an inquiry requesting authorization; computer readable program code to identify the type of request selected by the remote entity, and computer readable program code to perform an operation selected by the remote user.

A third embodiment of the present invention includes a first computer network or system having a terminal at a first (remote) location and at least one second (central) location which may include a database relating to a person for whom authorization is sought to complete a transaction at the remote location based on information earlier provided by the person to a government entity as required by law. The system may also include an additional database having information relating to the law-abiding activities of the person seeking authorization for a transaction. The system may further include an additional database including recent activities of the person seeking authorization for use in the determination of transaction authorization and for storing transaction information in a near-real time database accessible only by authorized persons or entities, such as law enforcement personnel.

Other aspects and features of the present invention are described in detail with reference to the following drawings.

### BRIEF DESCRIPTION OF THE DRAWINGS

FIG. 1 is a schematic block diagram of a system on which a method for authorization may be performed including at least one remote location and at least one central location participating in a computer network;

FIG. 2 is a flow chart depicting a method and computer program product of a first embodiment in accordance with the present invention;

FIG. 3 is a flow chart depicting a method and computer program module of the first embodiment of the invention;

FIG. 4 is a flowchart depicting a method and computer program module of the first embodiment of the invention; and

FIG. 5 is a flow chart depicting a method and computer program module of the first embodiment of the invention.

### DETAILED DESCRIPTION

As will be appreciated by one skilled in the art, aspects of the present invention may be embodied as a system, method and/or computer program. Accordingly, aspects of the present invention may take the form of an entirely hardware embodiment, an entirely software embodiment (including firmware, resident software, micro-code, etc.), or an embodiment combining software and hardware that may all be generally referred to as a “system.” Furthermore, aspects of the present invention may take the form of a computer program embodied in one or more computer readable mediums having computer readable program code embodied therein.

Any combination of one or more computer readable medium may be utilized such as a computer readable signal medium or a computer readable storage medium. A computer readable storage medium may be, for example, but not limited to, an electronic, magnetic, optical, electromagnetic, infrared or semiconductor system or any suitable combination of such system devices. More specifically, although a non-exhaustive list, examples of a computer readable storage medium would include an electrical connection having one or more wires, a portable computer diskette, a hard drive, RAM, ROM, EPROM, Flash memory, an optical fiber, a portable compact disc read-only memory (CD-ROM), an optical storage device, a magnetic storage device, or any suitable combination of the foregoing. In the context of this description, a computer readable storage medium may be any tangible medium that can contain or store for use by or in connection with an instruction execution system.

A computer readable signal medium may include a propagated data signal with computer readable program code embodied therein, for example, in baseband or as part of a carrier wave. Such a propagated signal may take any variety of forms including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, SmallTalk, C++, or the like or conventional procedural programming languages, such as the C programming language or similar programming languages. The programming code may execute entirely on the central computer, partly on the central computer and remote terminals or computers, as a stand-alone software package, partly on the central computer and partly on a remote computer or entirely on the central computer or server. In the latter scenario, the remote computer or terminal may be connected to the central computer through any type of network, including a local area network (“LAN”) or a wide area network (“WAN”), or the connection may be made to an external computer (for example through the Internet using an Internet service provider).

Aspects of the present invention are described below with reference to flow chart illustrations and/or block diagrams of methods, systems and computer program products according to embodiments of the invention. It will be understood that each block of the flow chart illustrations and/or block diagrams and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create structure for implementing the functions/acts specified in the flow chart and/or diagram blocks.

The computer program instructions may also be loaded on to a computer, other programmable data processing apparatus, or other devices to cause a series of operational steps to be performed on the computer, other programmable apparatus or other devices to produce a computer-implemented process such that the instructions would execute on the computer or other programmable apparatus to provide processes for implementing the functions/acts specified in the flow charts and/or diagram blocks. As used herein, a “terminal” should be understood to be any one of a general purpose computer, as for example, a personal computer, a laptop computer, a special purpose computer such as a server, a smart phone, a soft phone, a personal digital assistant, or any other machine adapted for executing programmable instructions in accordance with the description thereof set forth above.

While the invention is broad in scope and applies to all types of authorizations, a first method, system, and computer program product example embodiments are described herein relating to the authorization to purchase a product, such as liquor, firearms, ammunition, chemicals useable to create explosive devices, or medications useable for making illegal drugs, where according to state or Federal law, the consumer must be older than a minimum age, such as 21 years old or sale of the product requires a permit, license or other authorization. In addition, purchaser qualifications other than age may be established for authorization, such as the individual's history involving abusive alcohol consumption, criminal record, and/or motor vehicle transgressions. Moreover, information submitted by the consumer-purchaser, such as personal data on a driver's license or other ID card, may be authenticated prior to or after authorization.

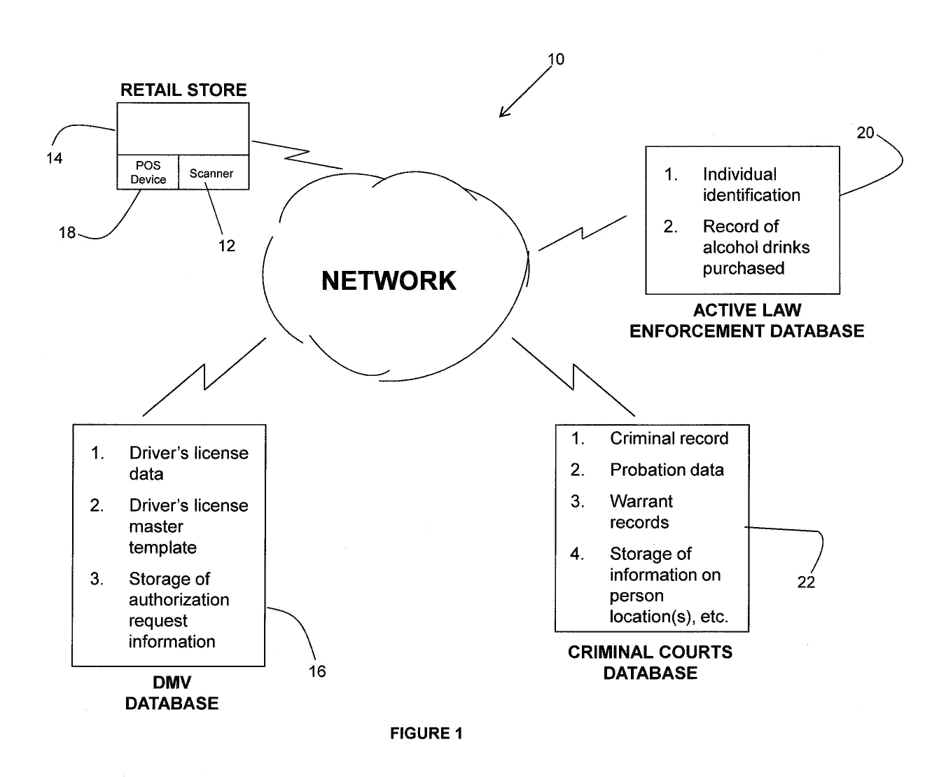

As seen in FIG. 1, a system 10 may be configured for authorizing the purchase of alcohol and may include a remote terminal, which may be or include a document scanner or reader 12 in this embodiment. The scanner may be located at a private site, such as retail store 14, remote from a central government-hosted location, and may capture information from a government-issued identification card, such as a motor vehicle driver's license. In one embodiment, utilizing scanner 12, the scanner may be capable of reading bar codes, magnetic stripes, RFID sensors as well as OCR codes that may be printed on an ID card. The card in the example embodiment may include a passive or active transponder that includes encoded information of the cardholder including for example the birth date of the cardholder. In addition, or alternatively, the scanner of the embodiment example may permanently or temporarily record an image of the entire card that contains, for example, a driver's license number, name and address, date of birth, expiration date, a photograph of the cardholder, a signature, and a symbol or logo indicating authenticity or genuineness of the card, including the positions, colors, fonts and similar card-related (rather than cardholder-related) information including visually printed material on the card to establish card genuineness or authenticity, that is, to reject a forged card. Other ID card authenticity information available on the card may include a hologram, digital watermark or fingerprint image.

For simple age verification, the terminal 12 of the embodiment example may include the capability of comparing the encoded date of birth on the card with a date automatically pre-set in the scanner, and mathematically compute whether the cardholder is of the required minimum age to complete a purchase. Alternatively, authorization may be performed at the central location database, for example, a Department of Motor Vehicles (DMV) database 16 where the consumer, cardholder information scanned is transmitted from the remote location 14 with the argument field containing the card date-of-birth whereby through computer processing, a comparison of the date-of-birth that is the minimum age for the date of the transaction with the received date-of-birth from the remote location verifies that the individual is qualified to purchase alcoholic products. The central computer system DMV database may provide a storage location for all authorization requests, or alternatively or cumulatively, the scanner 12 may store the information scanned from the card and the authorization (or failure to authorize) decision information may be stored in a POS device 18, thereby establishing a permanent record that the retail store involved in the transaction may subsequently use, if necessary, to prove that the sale was properly authorized, if for example, the store was later accused of selling liquor to a minor.

The system of the example embodiment is also capable of recording the information scanned both as to venue, date, and identification card information and store such information in a temporary short-term Active Law Enforcement Database (“ALED”) 20 for subsequent use of the authorized transaction information. It is a feature of modern public safety departments that there is a common database maintained for a variety of information. For example, many states have a Criminal Justice Information System that maintains, as indicated above, the criminal record of a resident of that state and that includes a complete dossier of the criminal, including his or her arrest and conviction record, type of offense, date, name, address, phone, driver's license number, race, sex, height, weight, hair color, eye color, scars and tattoos. In addition, some law enforcement agencies have a computer system with communication access to the National Crime Information Center that is maintained by the Federal Bureau of Investigation and is available to law enforcement agencies on a confidential and exclusive basis. The system comprises a computerized database that may be instantly available through a local agency system to an officer utilizing queries on a real-time basis. The NCIC is used to apprehend fugitives, locate missing persons, locate and return stolen property, and to protect law enforcement officers who encounter criminals having a record in the database. These records may contain information on stolen vehicles, vehicles used in the conduct of felonies, stolen vehicle parts including certificates of origin or title, stolen license plates, stolen boats, stolen guns, recovered guns, stolen articles, serialized counterfeit securities, and similar information.

The local jurisdiction database of criminal information for use by law enforcement officers may be accessed using wireless technology and mobile terminals or mobile smart phones. Typically this information is available upon query on a real-time basis. These cruiser-mounted or hand-held terminals are used for a variety of purposes but in reference to the present invention, may be used to obtain information about a person who may have been stopped for some vehicle or other violation of local jurisdiction laws. One embodiment of the present invention may include the storage of transactional data relating to a specific individual similar to that described above. For example, in venues where alcoholic beverages are served, such as a bar, restaurant, or tavern, each purchase of alcohol may be recorded and stored in the ALED database of the example embodiment for a selected period of time, for example, 24 hours. For the cardholder, multiple visits to alcohol serving venues or multiple purchases within the same venue are accumulated thus providing a short-term historical record of the alcoholic purchases during a specified period. Another capability of the system of the example embodiment may provide a record of cumulative drinks within a given period of time in the ALED, and then provide a “no authorization” message to the alcohol-serving venue preventing the user from engaging in improper conduct under the influence of too much alcohol.

Furthermore, in accordance with government policy, the scanned information regarding the card holder may be used to access a state-wide Criminal Courts Database 22 including criminal warrants. The existence of a criminal warrant may disqualify the cardholder from purchasing the alcoholic beverage but more importantly, the transaction, whether attempted or completed, would record the driver's license information of the cardholder and be supplied to a storage area in the Criminal Courts database that stores information regarding the whereabouts of persons for whom criminal warrants are outstanding. Cumulative storage of such information may provide law enforcement entities with needed information for apprehending the person that is evading the warrant.

The Criminal Courts Database 22 of the first embodiment may include another database that includes court-ordered probation information for persons that have been convicted of various crimes and for whom the court has ordered that the cardholder is not permitted to purchase alcohol or firearms or other proscribed products as described above. The attempt to purchase the alcoholic beverage would be recorded at the time the cardholder's information is scanned and would be supplied to the ALED as well as stored in the person's probation file.

The system of the example embodiment is also capable of using types of venue authorization devices other than from typical driver's license personal data. For example, devices are currently available that will identify the bearer's fingerprint, palm print, or even a DNA profile. Other input devices may include the determination of eye patterns. That information could be encoded into appropriate magnetic or optical storage on the identification card in the example embodiment. A sophisticated biometric scanning device may be more effective in preventing the fraudulent use of another person's card, even though the two persons resemble each other photographically, by utilizing a scanner that, for example, scans the eye of the cardholder-purchaser and compares it with the eye pattern encoded on the identification card or an eye pattern that is retained in a system database at a remote location but is easily accessible over communication paths.

The system of the example embodiment further provides for authorizing open-container sales transactions in the venues suggested above by recording of each purchase of an alcoholic beverage by the cardholder and providing that data to, for example, a fourth database. Each such sale of an alcoholic drink may be cumulated in the database for a period of, for example, eight hours. If the cardholder, subsequent to the purchase of the alcoholic beverages, is later stopped by law enforcement officers, for example, in a motor vehicle violation or accident, the cardholder's license, when scanned by the police officer which has access to the above-described law enforcement database would indicate to the officer the number of alcoholic drinks that had been purchased by the person stopped, during a period of time that may be relevant to the sobriety condition of the driver. The system of the exemplary embodiment can be evaded by an individual who employs a second individual to purchase alcoholic drinks so as to prevent the recording of data regarding the number of alcoholic beverages consumed. However, the system of the embodiment will have some value because if the individual drinks alone or ignores the avoidance scheme because they are too inebriated to assess the desirability of avoidance, the data will be available and DUI/DWI offenders can be apprehended.

In addition to the government-issued common driver's license, private identification cards may be desired for certain transactions. For example, a credit or debit card can serve as the source for authorization information, or an employee identification card, a military identification card, a passport, a photo registration card, an immigration card, a student identification card, or similar identification cards may be required or satisfied depending on the nature of the transaction. Each of these cards are issued by private organizations or entities and in each case a database will be maintained with personal information of the cardholder. It is entirely within the discretion of the issuing organization to place restrictions of the use of the card. When scanned, the card data may be transmitted to a remote database where card authentication and authorization may be determined. Moreover, as in the above-described law enforcement active near real-time database, transactions, for example entry or exit, may be immediately available to persons or organizations, other than at the authorization venue, to permit such persons or organizations to take immediate action, such as surveillance or monitoring.

The database 16 of the example embodiment may include other information, such as a record that the identification card being scanned has been reported as lost or stolen. The system of the example embodiment may also accommodate more than one level of authorization. For example, on a military base, at points of access control, there may be areas in which a person with a first level of authorization is allowed on the base but a second, more particularized authorization, is required for entry into a second more secured area of the base.

A wide variety of databases may be employed in the above-described system including both public and private information. As an example of private information, pre-stored information regarding employees of a company in a central database and their access to certain facilities or areas within the company premises may be used in conjunction with an employee badge that at various control points grants the employee access to a particular area. As noted above, transmission of authorized entry may be stored in a temporary database that on a near real-time basis may be accessed by additional personnel or by further non-manned devices, such as door locks, permitting the cardholder further authorized entry or access.

As a public example, the database may be a national or international database system or network that includes information regarding criminal activities of various persons who may seek to purchase certain products or services and/or gain access to certain premises and whose authorization may depend upon their status within the database. For example, a database that includes criminal records of an individual may be usable in conjunction with the purchase of firearms, that is, a venue that sells firearms may have a scanning device that obtains information regarding the cardholder and that information is then transmitted to a central data site where certain criminal information may be available and after a match of individual identification characteristics will inform the venue that the person is or is not authorized to purchase firearms. As another public example, there are certain states in which persons are authorized to purchase only one handgun within the state per month. Thus, upon purchase of a single handgun, when the customer attempts to purchase a second handgun, the cardholder information submitted, will be transmitted to a temporary database that contains handgun purchase transactions within the last 30 days and may authorize, or refuse authorization, based on state law legal requirements. As in the above-described system, the information can be transmitted to still another database that is an active law enforcement database which would store the latest transaction data would be immediately available to law enforcement officers, who may be properly suspicious of the customer attempting to purchase a second handgun during the proscribed period as an indication that the individual is arming himself or herself for improper conduct or may indicate that the individual is brokering handguns to criminals. The near real-time availability of that information to law enforcement officers may thus assist in public safety quite aside from the authorization or non-authorization function of the system and method of the present invention.

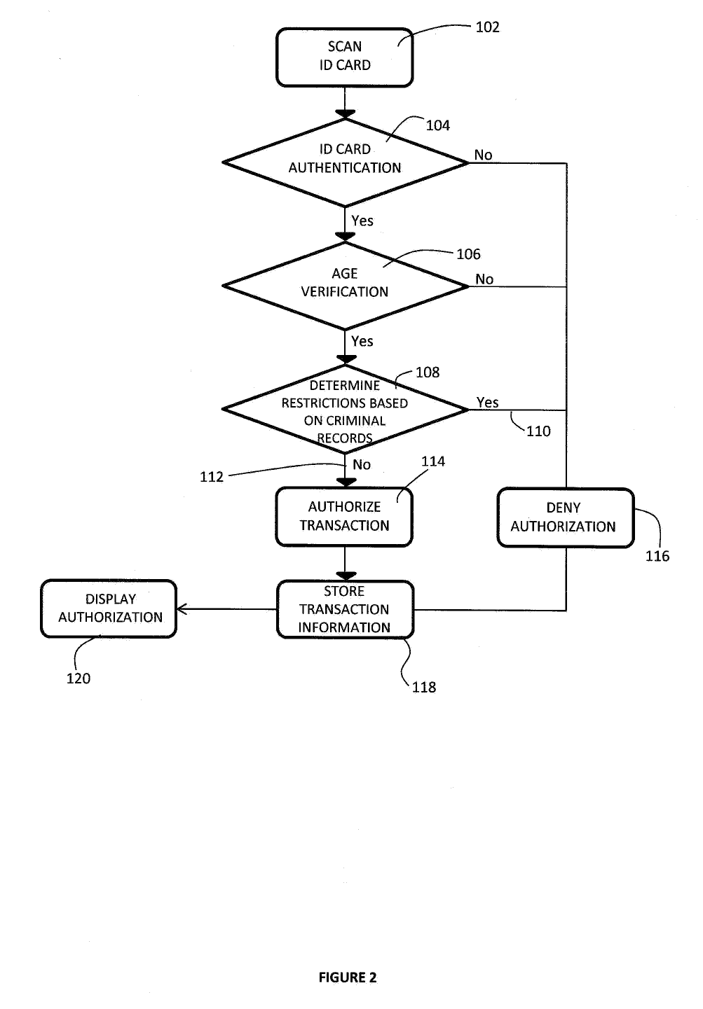

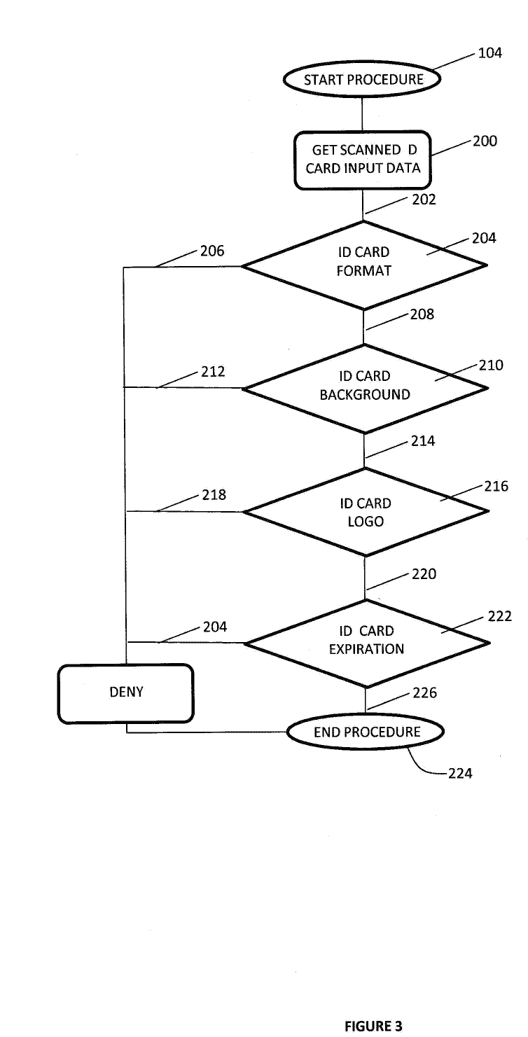

A system of the exemplary embodiment for determining eligibility for purchase of alcoholic beverages includes monitoring and controlling sales of alcohol products and determining authorization to sell such products utilizing an example method and computer program product set forth in the accompanying total-transaction flow diagram (FIG. 2) that traces the major steps of the method and the major program modules of the overall first embodiment when employed for the purpose of determining authorization for sale of an alcoholic beverage. In reference to FIG. 2, the method for obtaining authorization commences with scanning 102 input information from the customer identification card. The identification card includes predetermined regions which may include the jurisdiction (for example, the State), a jurisdiction logo, document type, name and address of individual cardholder, particulars of the individual, signature of the individual, photograph of the individual, identification number of the document, the date of birth, and other information that may have been previously collected by a governmental entity. The identification card may also have a background or logo that serves as an authentication code. The authentication process 104 may include various modules for authenticating data from the identification card, as now described in reference to the FIG. 3 flowchart.

For example, the license format may be compared to a master template format of the identification card in the particular State. Another program module or segment may compare the background of the identification card with a master template to determine whether the identification card is genuine. Another authentication step may be directed to the State logo which is again compared to a master template to ascertain that the card is not a forgery. Still another segment may check to determine that the card has not expired. As shown best in FIG. 3, the scanned ID card input data 200 is output on signal path 202 to ID card format process 204 in which the ID card format is authenticated; if the format is not authentic, the format decision process 204 outputs an authentication denial on path 206 and conversely if the format is verified, the decisional process, or module, or segment 204 will output a positive authentication output on path 208. The ID card background module or decisional segment 210 receives the signal from path 208 and executes a comparison of the ID card background to the master template; if the ID card background is not authentic, authorization is denied by a signal on path 212. If the ID card background authentication segment is positive, a signal is sent on path 214 to an additional module or decisional segment for the ID card logo at 216 where the ID card logo is compared to a master logo; if there is no match of the ID card logo with the master logo template, a signal is sent on path 218 so as to deny authorization. If the ID card logo is authentic, a signal is sent on path 220 to decisional segment 222 which determines whether the ID card has expired. If the ID card has expired, procedure 222 sends a signal on path 224 to deny authorization. On the other hand, if the card has not expired, then ID card expiration segment 222 will end the authentication procedure at 224 through path 226 and will send a signal to age verification procedure 106 as shown on FIG. 2. If any of the decision modules 204, 210, 216 or 222 has a negative output, the end of procedure 224 is reached in the Deny State 226 from which acceptance or denial of authenticity is transmitted to a remote location, for example.

The age verification module 106, as earlier described, involves only a simple comparison of the cardholder age with a calendar and grants authorization or, in the example embodiment, invokes the Criminal Records decisional module 108 if age is properly verified.

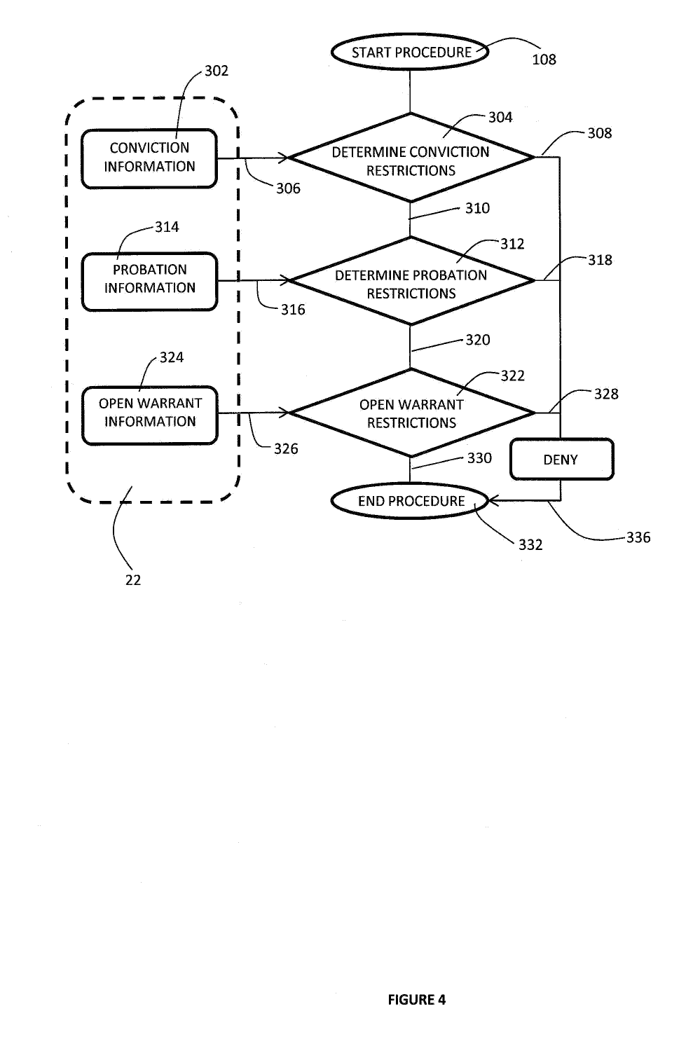

Turning to FIG. 4, the procedure 108 is initiated to determine, if based on the cardholder's criminal record, there are any restrictions that should prevent the card holder from completing the proposed transaction. For example, the cardholder may have had criminal convictions as stored in the Criminal Courts Database 22 that under applicable state law prohibit the cardholder from engaging in the transaction. The conviction information 302 in Criminal Courts Database 22 is transmitted on path 306 to the decisional subroutine or module 304 that determines and outputs a negative determination conviction restriction on path 308. If there are no restrictions then a positive signal is sent on path 310 to procedure segment or module 312 where court-based probation information 314 regarding the cardholder is transmitted on path 316 and a determination is made whether conditions of probation prohibit the transaction. If there is a restriction, then decisional segment 312 will output on path 318 a signal denying authorization; if there are no restrictions, then the probation restriction determination decisional segment 312 will output a signal along path 320 to the open warrant restriction decisional segment 322. Open warrant information is stored in court records database 324 where the presence of an open warrant transmitted on path 326 will automatically deny authorization for the transaction and a signal will be sent on path 328 denying authorization. Conversely, if there are no open warrants, then the open warrant decisional segment will pass a signal on path 330. The procedure 108 ends at 332 from a positive signal along path 330 or a negative signal along path 336 based on negative signals 308, 318 or 328.

The output of the process 108, if restrictions are found, provides a signal on path 110 denying authorization. If the two decisional segments 104 and 106 are positive and 108 is negative, then an authorization signal is sent on path 112 to state 114. Conversely, a signal along path 110 will deny authorization at state 116. Upon receiving either a denial or authorization for the transaction, the information may be captured in a computer readable storage medium 118 and the authorization or denial thereof may be displayed at the remote site on a display of POS device 18.

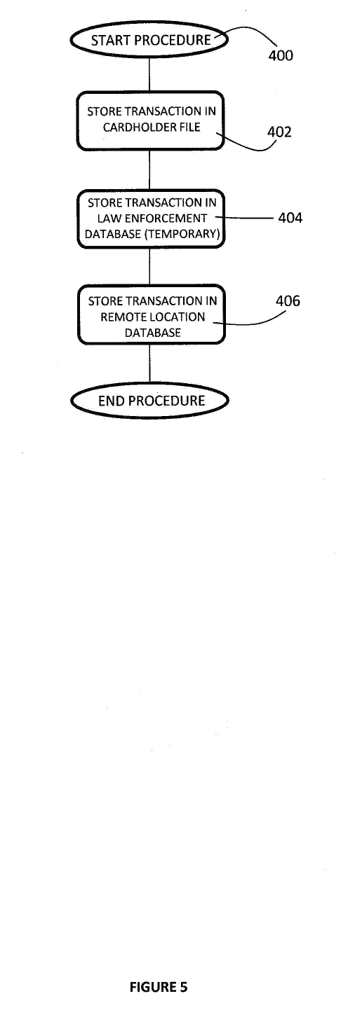

Referring to FIG. 5, the transaction data, including authorization or denial, may be stored in one or more storage areas or locations in one or more databases. The storage process may commence with procedure 400 and include storing the transaction data in the cardholder's file at state 402 in, for example, the DMV database 16. In addition, the transaction data is stored at state 404 in the ALED 20, the active law enforcement database. The latter database storage may be temporary or permanent and used as described above.

The transaction data may also be stored by process 406 in the POS Device 18 at the retail store 14 as a permanent record of the cardholder's transaction for subsequent utilization as described above.

The flowchart and block diagrams in the figures illustrate the architecture, functionality and operation of possible implementations of systems, methods and computer program products according to various embodiments of the present invention. In this regard, each block in the flowchart may represent a procedure, module, segment, routine or portion of code, which comprises one or more executable instructions for implementing the specified logical function(s). It should also be noted that, in some alternative implementations, the functions or steps noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular terms “a,” “an” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof. Moreover, the word “authentication” is used to describe the process of determining whether input data, or whatever type, is genuine, that is, not a forgery. The word “authorization” is used to describe the process of determining, based on the input data and public laws or private restrictions whether a proposed transaction is legal or complies with private issuer restrictions,

The corresponding structures, materials, acts, and equivalents of all means or step plus function elements in the claims below are intended to include any structure, material, or act for performing the function in combination with other claimed elements and specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical applications, and to enable others of ordinary skill in the art to understand the invention for various embodiments with various modifications as are suited to the particular use contemplated.

While the specific embodiment described above relates to the sale of alcoholic beverages, it will be understood by those of ordinary skill in the art that other types of purchases, of goods or services, or access to premises, can similarly be integrated with the prior art hardware scanners, network and computer database, with law enforcement and court-ordered restrictions in addition to the age-qualification requirements and thus provide a system having active information that will discourage or prevent the use of alcohol particularly in vehicle incidents and thus make the road safer for the general public.

1. A method for authorizing a transaction comprising:
obtaining information relating to a potential purchaser at a remote location;
transmitting said purchaser information to a central site in a message that includes purchaser personal data that may qualify the purchaser to complete a proposed transaction and the identity of the remote location;
storing legal information at a central site that specifies requirements for authorization of a transaction;
comparing said purchaser personal data with said legal requirement information;
determining whether the purchaser personal data complies with the legal requirements and is authorized;
storing the potential purchaser personal data, the remote location identity, and the date and time of the transmission from the remote location;
transmitting the determination of authorization to the remote location; and
storing the transaction authorization in a temporary database available for near real time access solely by law enforcement officers.

2. The method of claim 1 additionally comprising the step of storing criminal records information, at a site other than the remote location, transmitting the purchaser personal data to the other site, comparing the purchaser personal data with the stored criminal records information, determining whether the transaction complies with legal requirements relating to the purchaser's personal data and the criminal records, and transmitting the determination of authorization to the remote site.

3. The method of claim 2 wherein said criminal records include probation terms and conditions.

4. The method of claim 2 wherein said criminal records include outstanding arrest warrants.

5. The method of claim 1 wherein the step of obtaining information relating to a potential purchaser includes scanning of a purchaser's government issued identification card.

6. The method of claim 5 wherein the scanning step includes obtaining an image of the front and/or back of the identification card, transmitting that image to another site, storing a master template image of an authentic identification card at the other site, comparing said scanned image to said master template image, determining if the scanned image is genuine, and transmitting said determination to said remote location.

7. The method of claim 1 wherein said step of temporarily storing the transaction authorization includes storing every transaction authorization for a fixed period of time equal to less than a month.

8. The method of claim 7 wherein said temporary storage period is twenty-four hours.

9. The method of claim 1 wherein the temporary storage location is under the control of a law enforcement entity.

10. A computer program product comprising:
a computer readable storage medium having computer readable program code embodied therewith, the computer readable program code comprising:
computer readable program code for receiving scanned input data regarding a person seeking authorization of a proposed transaction at a remote site;
computer readable program code for authenticating the input data;
computer readable program code containing personal information regarding the person seeking authorization;
computer readable program code for comparing the scanned input data with the personal information;
computer readable program code for determining authorization of the proposed transaction;
computer readable program code for storing the transaction data with the personal information; and
computer readable program code for storing the transaction data in an active database accessed exclusively by law enforcement officers.

11. The computer readable program code of claim 10 wherein the scanned input data includes personal age information.

12. The computer readable program code of claim 11 wherein the scanned input data is obtained from a driver's license.

13. The computer readable program code of claim 12 wherein the personal information includes drivers license information.

14. The computer readable program code of claim 13 wherein the scanned input data personal age information is compared to a current date to determine if the person's age authorizes the proposed transaction.

15. The computer readable program code of claim 10 wherein the input data is obtained from a scan of a driver's license.

16. The computer readable program code of claim 15 wherein the scan comprises an image of the license.

17. The computer readable program code of claim 16, wherein the scanned input data image is compared to an image template of a driver's license created by a governmental entity.

18. A system for authorizing and storing a proposed transaction comprising:
a terminal located at a retail site selling a product for scanning a person's driver's license;
a central site including a computer database of issued drivers licenses;
a communication system interconnecting the terminal and central site;
a computer program for receiving the scanned information;
a computer program for comparing the scanned driver's license with a template of issued drivers licenses for authenticating the scanned driver's license;
a second computer program for determining if the age or other personal data of the person carrying the driver's license is authorized to purchase the product;
a transmitter for sending authorization to the terminal; and
a law enforcement database for receiving transaction information on a near-real time basis and making such transaction information available exclusively to law enforcement officers.

19. The system of claim 18 wherein the law enforcement database transaction information is only temporarily stored.
